(19) United States
(12) Patent Application Publication
(10) Pub. No.: US 2001/0037820 A1
(43) Pub. Date: Nov. 8, 2001

(54) Method for fluorometrically monitoring and controlling water used in semiconductor chip production

(76) Inventors: Brian V. Jenkins, Warrenville, IL (US); John E. Hoots, St. Charles, IL (US)

Correspondence Address: Margaret Meta Brumm, Patent & Licensing Department, ONDEO Nalco Company, ONDEO Nalco Center, Naperville, IL, 60563-1198, US

(21) Appl. No.: 09/825,425

(22) Filed: Apr. 3, 2001

Related U.S. Application Data
(63) Continuation-in-part of application No. 09/334,189, filed on Jun. 16, 1999, now Pat. No. 6,238,487.
Application No. 09/334,189 is a division of application No. 08/931,556, filed on Sep. 16, 1997, now Pat. No. 5,922,606.

(51) Int. Cl. B08B 3/04; B08B 13/00

(52) U.S. Cl. 134/18

(57) ABSTRACT

A fluorometric method of ascertaining the purity of water used in semiconductor processing is described and claimed. A fluorometric method for monitoring and optionally controlling the water used in a semiconductor chip manufacturing process is also described.

### CROSS-REFERENCE TO RELATED PATENT APPLICATIONS

This application is a continuation-in-part of patent application Ser. No. 09/334,189, filed on Jun. 16, 1999, now pending, which is a divisional of patent application Ser. No. 08/931,556, filed Sep. 16, 1997, now U.S. Pat. No. 5,922,606.

### FIELD OF THE INVENTION

The present invention relates to methods for increasing the efficiency of semiconductor chip production. More specifically, the present invention relates to method for increasing the efficiency of semiconductor chip production by monitoring the water used in semiconductor chip process streams using fluorometric analytical techniques.

### BACKGROUND OF THE INVENTION

Semiconductor chip production involves a series of various process stages, such as cleaning, rinsing, polishing, fabricating, etching, and the like. The various semiconductor chip process stages can include a variety of different and number of process streams that contact the semiconductor chip during production. The process streams can include a variety of different process components, such as, water, acids, alkalines, organics, slurries, and the like. For all of the aqueous streams, the quality of the water used in the stream is of extreme importance because high purity of water is required in order to make successful semiconductor devices.

Semiconductor devices, whether of the single element or integrated circuit type, are fabricated universally from monocrystalline material in slice form. Each slice provides a large number of devices. Semiconductor discs are obtained from monocrystalline semiconductor rods by sawing the rods into sections. The discs are then attached to polishing plates with, for example, beeswax, a synthetic wax or another adhesive and polished using a polishing agent. The polished discs are contaminated with the adhesive, traces of the polishing agent, and with other impurities. Since even small amounts of impurities can cause considerable variation of the electrical parameters of the finished structural elements, the discs have to be thoroughly cleaned to remove the impurities.

The cleaning of the polished discs is usually effected in two successive essentially different operations: first, a washing operation involving dissolution and rinsing operations and, secondly, a mechanical cleaning operation to remove the last traces of impurities from the disc surface.

The washing step, as generally carried out, involves a number of separate operations. The wax, cement or other adhesive remains are first removed by dissolution in a convenient solvent, which is suitable in an ultrasonic tank or a steam vessel. An example of such solvent is trichloroethylene. The discs are then washed with acetone to remove any remaining trichloroethylene, after which they are rinsed with water. They are then immersed in concentrated nitric acid and again rinsed with water. The discs are usually then immersed in hydrofluoric acid so as to render their surfaces hydrophobic, and once more rinsed with water. There then follows the mechanical cleaning stage consisting mostly of wiping or rubbing with suitable rags. It is apparent that the washing operation is complicated, time-consuming, and expensive.

Water is used at every step in the production of semiconductors, either by itself or within a stream containing other ingredients. The correct amount of water must be used at each step of processing. Because this water is very highly treated water it is very expensive. Thus it is important that the semiconductor manufacturing process be monitored and controlled so that the correct amount of water, but not an expensive over amount of water, is used.

Semiconductor process water must be of a certain purity in order to function for the intended purpose without leaving unacceptable deposits upon the semiconductors. The purity is controlled by industry standards. The purity of the water is tested using standard analytical techniques. These tests are expensive and time consuming.

It is desirable to develop alternative test methods to ascertain the purity of the water used as well as to monitor and control the presence of the water throughout the semiconductor processes.

### SUMMARY OF THE INVENTION

The first aspect of the instant claimed invention is a fluorometric method of ascertaining the purity of water used in semiconductor processing comprising the steps of:

a) providing the water used in semiconductor processing;

b) providing a modular fluorometer comprising from one to 16 individual modular fluorometer units;

c) moving a sample of water from said water used in semiconductor processing through the channel of said modular fluorometer;

d) using said modular fluorometer units to detect the fluorescent signal detectable at from one to sixteen emission wavelengths;

e) comparing the detected fluorescent signals with the quality control settings for allowable fluorescent signals and using this comparison to determine whether said water used in said semiconductor process is acceptable.

The second aspect of the instant claimed invention is a fluorometric method for monitoring and optionally controlling a semiconductor chip manufacturing process, the method comprising the steps of:

a) providing water suitable for use in a semiconductor chip process stream;

b) providing at least one suitable fluorometer;

c) providing a suitable inert fluorescent moiety;

d) adding said suitable inert fluorescent moiety to said water suitable for use in a semiconductor chip process stream;

e) using said fluorometer to detect the fluorescent signal of said suitable inert fluorescent moiety; and

f) using the fluorescent signal of said suitable inert fluorescent moiety to monitor and optionally control said semiconductor chip manufacturing process.

### DETAILED DESCRIPTION OF THE INVENTION

Throughout this patent application, the following terms have the indicated meanings:

“Nalco” refers to ONDEO Nalco Chemical Company, One ONDEO Nalco Center, Naperville, Ill. 60563 (630) 305-1000.

“Turner” refers to Turner Designs, 845 West Maude Avenue, Sunnyvale Calif. 94086, (408) 749-0994.

The meaning of the term “inert”, as used herein is that an inert fluorescent moiety is not appreciably or significantly affected by any other chemistry in the system, or by the other system parameters such as metallurgical composition, microbiological activity, biocide concentration, heat changes or overall heat content. To quantify what is meant by “not appreciably or significantly affected”, this statement means that an inert fluorescent moiety has no more than a 10% change in its fluorescent signal, under conditions normally encountered in semiconductor process streams. People of ordinary skill in the art of semiconductors know of ordinary conditions normally encountered in semiconductor process streams.

The first aspect of the instant claimed invention is a method of ascertaining the purity of water used in semiconductor processing comprising the steps of:

a) providing the water used in semiconductor processing;

b) providing a modular fluorometer comprising from one to 16 individual modular fluorometer units;

c) moving a sample of water from said water used in semiconductor processing through the channel of said modular fluorometer;

d) using said modular fluorometer units to detect the fluorescent signal detectable at from one to sixteen emission wavelengths;

e) comparing the detected fluorescent signals with the quality control settings for allowable fluorescent signals and using this comparison to determine whether said water used in said semiconductor process is acceptable. Water used in semiconductor processing must meet strict industry standards. One compilation of those industry standards is given in the exacting standards of such organizations as the American Standards for Testing Materials (“ASTM”).

ASTM D 5127-99, entitled “Standard Guide for Ultra Pure Water Used in the Electronics and Semiconductor Industry”, describes the recommendations for water quality related to current electronics and semiconductor industry requirements. The following Table lists the actual requirements for six different types of water used in the electronics and semiconductor industry.

The six types of water included in the table are defined as follows:

Type E-1 - This water is classified as microelectronic water to be used in the production of devices having line widths between 0.5 and 1.0 μm.

Type E-1.1 - This water is classified as microelectronic water to be used in the production of devices having line widths between 0.25 and 0.5 μm.

Type E-1.2 - This water is classified as microelectronic water to be used in the production of devices having line widths between 0.18 and 0.25 μm. It is the water of ultimate practical purity produced in large volumes and is intended for the most critical uses.

Type E-2 - This water is classified as microelectronic water to be used in the production of devices that have dimensions between 1 and 5 μm.

Type E-3 - This grade of water is classified as macroelectronic water to be used in the production of devices having dimensions larger than 5 μm. This grade may be used to produce larger components and some small components not affected by trace amounts of impurities.

Type E-4 - This may be classified as electroplating water to be used in the preparation of plating solutions, the production of certain electronic grade chemicals, and other applications where the water being used is in constant contact with the atmosphere because of tank storage. This water purity is based upon the fact that the water may have had a significantly higher purity, but that it becomes contaminated because of tank storage and handling.

TABLE 1
Requirements for Water Used in the Electronics and Semiconductor Industry

| Parameter | Type E-1 | Type E-1.1 | Type E-1.2 | Type E-2 | Type E-3 | Type E-4 |
|---|---|---|---|---|---|---|
| Linewidth (microns) | 1.0-0.5 | 0.5-0.25 | 0.25-0.18 | 5.0-1.0 | >5.0 | — |
| Resistivity, 25° C. | 18.2 | 18.2 | 18.2 | 17.5 | 12 | 0.5 |
| Endotoxin unit | 0.03 | 0.03 | 0.03 | 0.25 | — | — |
| TOC (μg/L) | 5 | 2 | 1 | 50 | 300 | 1000 |
| Dissolved oxygen | 1 | 1 | 1 | — | — | — |
| Residue after | 1 | 0.5 | 0.1 | — | — | — |
| evaporation (μg/L) | | | | | | |
| SEM particle/L (micron | | | | | | |
| 0.1-0.2 | 1000 | 1000 | 200 | — | — | — |
| 0.2-0.5 | 500 | 500 | 100 | 3000 | — | — |
| 0.5-1 | 50 | 50 | 1 | — | 10000 | — |
| 10 | — | — | — | — | — | 100000 |
| Online particles/L | | | | | | |
| 0.05-0.1 | 500 | 500 | 100 | — | — | — |
| 0.1-0.2 | 300 | 300 | 50 | — | — | — |
| 0.2-0.3 | 50 | 50 | 20 | — | — | — |
| 0.3-0.5 | 20 | 20 | 10 | — | — | — |
| >0.5 | 4 | 4 | 1 | — | — | — |
| Bacteria/100 ML | | | | | | |
| 100 mL Sample | 1 | 1 | 1 | — | — | — |
| 1 L Sample | 1 | 1 | 0.1 | 10 | 10000 | 100000 |
| Silica-total (μg/L) | 3 | 0.5 | 0.5 | 10 | 50 | 1000 |
| Silica-dissolved | 1 | 0.1 | 0.05 | — | — | — |
| Ions and metals (μg/L) | | | | | | |
| Ammonium | 0.1 | 0.10 | 0.05 | — | — | — |
| Bromide | 0.1 | 0.05 | 0.02 | — | — | — |
| Chloride | 0.1 | 0.05 | 0.02 | 1 | 10 | 1000 |
| Fluoride | 0.1 | 0.05 | 0.03 | — | — | — |
| Nitrate | 0.1 | 0.05 | 0.02 | 1 | 5 | 500 |
| Nitrite | 0.1 | 0.05 | 0.02 | — | — | — |
| Phosphate | 0.1 | 0.05 | 0.02 | 1 | 5 | 500 |
| Sulfate | 0.1 | 0.05 | 0.02 | 1 | 5 | 500 |
| Aluminum | 0.05 | 0.02 | 0.005 | — | — | — |
| Barium | 0.05 | 0.02 | 0.001 | — | — | — |
| Boron | 0.05 | 0.02 | 0.005 | — | — | — |
| Calcium | 0.05 | 0.02 | 0.002 | — | — | — |
| Chromium | 0.05 | 0.02 | 0.002 | — | — | — |
| Copper | 0.05 | 0.02 | 0.002 | 1 | 2 | 500 |
| Iron | 0.05 | 0.02 | 0.002 | — | — | — |
| Lead | 0.05 | 0.02 | 0.005 | — | — | — |
| Lithium | 0.05 | 0.02 | 0.003 | — | — | — |
| Magnesium | 0.05 | 0.02 | 0.002 | — | — | — |
| Manganese | 0.05 | 0.02 | 0.002 | — | — | — |
| Nickel | 0.05 | 0.02 | 0.002 | 1 | 2 | 500 |
| Potassium | 0.05 | 0.02 | 0.005 | 2 | 5 | 500 |
| Sodium | 0.05 | 0.02 | 0.005 | 1 | 5 | 1000 |
| Strontium | 0.05 | 0.02 | 0.001 | — | — | — |
| Zinc | 0.05 | 0.02 | 0.002 | 1 | 5 | 500 |

Water capable of meeting these standards can be purchased commercially or prepared by following industry known techniques such as those described in the reference, “High-Purity Water Preparation” by Theodore H. Meltzer, © 1993 by Tall Oaks Publishing Company, Library of Congress Catalog Card Number 92-85421. Chapter 13, pages 643-683, of the Meltzer reference describes “System Design for Semiconductor Manufacturing”. This chapter describes techniques known to people of ordinary skill in the art of water preparation for semiconductor manufacturing.

Modular fluorometers useful in the method of the instant claimed invention are available commercially from Nalco or Turner. The preferred modular fluorometer is available from Nalco and is described and claimed in pending U.S. Patent Application No. 09/583,086, entitled, MODULAR FLUOROMETER AND METHOD OF USING SAME TO DETECT ONE OR MORE FLUOROPHORES. This patent application, in its entirety, is incorporated by reference herein.

The process water described in Table 1 would typically have no fluorescent signals because there are and should be no fluorescing moieties present in the water. Therefore, the quality control standard for this water would have no fluorescent signals being the base line for use of the water.

Each module of the modular fluorometer is set to an excitation and emission wavelength about 20 nanometers away from that of the wavelength of the adjacent module. In this way, the entire spectrum of fluorescent signals from the most probable contaminants may be monitored. Should any fluorescent signal be detected, then that “batch” of process water would be further analyzed until the contaminant responsible for the fluorescent signal had been identified and eliminated.

When any fluorescent signal is detected, its excitation and emission wavelength are compared to known excitation and emission wavelengths in an attempt to do a “first cut” analysis of what the contaminant might be. Identification of these contaminants begins with some general known realities about fluorescent compounds; namely, most organic compounds that exhibit fluorescence are aromatic compounds with highly conjugated structures. And it is known that intensely fluorescent aromatic molecules are typically characterized by rigid, planar structures. The limitations on this method include the fact that if aliphatic and saturated cyclic organic compounds are present as contaminants, they will not be detectable using a fluorometer, because these types of compounds do not have detectable fluorescent signal.

Of course, it is known technology to add reagents to water samples in order to react with non-fluorescent compounds to give them a detectable fluorescent signal from which the amount of contaminant can be determined. See U.S. Patent No.'s 5,278,074; 5,389,548; 5,411,889 and 5,435,969. Because the method of the instant claimed invention is designed to be a “screening” analytical method, it is not anticipated that the operator will be aware of exactly what type of contaminants are likely to be present in the test water. Absent knowledge of what contaminant is likely to be present, use of a reagent to influence a fluorescent signal is not recommended for the method of the instant claimed invention.

Contaminants that have a fluorescent signal include, but are not limited to the following: aromatic compounds with conjugated structures such as anthracene, benzene, naphthalene, pyrene, quinoline, toluene, xylene, aromatic compounds with functional groups known in the art of aromatic compound chemistry (e.g. amines, alcohols, carboxylates, phthalates, sulfonates, etc. etc.), and mixtures thereof. Within the list of aromatic compounds, it is known that as the number of aromatic rings is increased, the fluorescence intensity, and the wavelength of the fluorescence emission also increases.

This list is not exhaustive, as any component of any process stream may be suitably and directly analyzed by the fluorometric analytical technique of the instant claimed invention provided that the component has fluorescing capabilities.

After the fluorescent signal of the contaminant has been detected, then, further analytical techniques can be done in order to identify the contaminant and decide how to separate the contaminant from the semiconductor process water.

The second aspect of the instant claimed invention is a fluorometric method for monitoring and optionally controlling a semiconductor chip manufacturing process, the method comprising the steps of:

a) providing water suitable for use in a semiconductor chip process stream;

b) providing at least one suitable fluorometer;

c) providing a suitable inert fluorescent moiety;

d) adding said suitable inert fluorescent moiety to said water suitable for use in a semiconductor chip process stream;

e) using said fluorometer to detect the fluorescent signal of said suitable inert fluorescent moiety;

f) using the fluorescent signal of said suitable inert fluorescent moiety to monitor and optionally control said semiconductor chip manufacturing process.

In order to select the appropriate inert fluorescent moiety to use in water to be used in a semiconductor process stream, the following criteria are used:

(1) Identify key operating conditions and requirements of the application which will influence which tracer chemical is chosen. This is necessary no matter what type of chemistry and analysis method are chosen.

(a) spectral properties of system fluid and substances in the fluid (e.g., light absorbance vs. wavelength), this must be done with regard to the fact that inert tracers are known over the spectral range of 200-800 nanometers;

(b) determine if system is a homogenous fluid or heterogenous fluid (e.g., clean water vs. slurry)

(c) concentration and type of dissolved ions/substances commonly present;

(d) concentration and type of substances (e.g., process leaks) which be sporadically present

(e) any government approvals which may be needed (e.g., FDA, EPA, NSF, TSCA, etc.);

(f) operating characteristics of the system (e.g., residence time (HTI) of fluids in the system, temperature, etc.);

(g) type of measurement needed (e.g., dosage control, flowrate, system volume, leak detection, etc.);

(h) concentration of tracer moiety which is needed/acceptable (e.g., maximum level based on cost, minimum level based on detection limit required, any effluent restriction on dosage, etc.) in order to meet accuracy/precision of analysis requirements;

(i) formulation stability if fed as a part of another product;

(j) absence of serious toxicity (level and type --e.g., mutagenic or not, etc.); and

(k) any other criteria which may have a practical impact on which inert tracer chemistry and analysis method is used.

(2) Determine if any interferences to the inert tracer chemical/analysis method exist (based on the list above) and determine if those interferences can be reduced/eliminated (e.g., filtering the fluid)

(3) Determine if an inert tracer moiety exists which is already used in other applications will also meet the criteria listed above.

(4) Determine if interferences with the measurement of the inert tracer moiety exist due to any conditions.

(5) If no known inert tracer moiety is found to be suitable in item #2, then determine if other compounds/methods are available (either commercially or in the scientific literature).

(6) If no inert tracer moiety exists which meets the criteria listed above - then new compounds may be synthesized and new analysis methods developed.

Known, suitable inert fluorescent tracer moieties are selected from the group including the mono-, di- and tri-sulfonated naphthalenes, including their known water-soluble salts; and the known sulfonated derivatives of pyrene, such as 1,3,6,8-pyrenetetrasulfonic acid, along with the known water-soluble salts of all of these materials, 2-Anthracenesulfonic acid, sodium salt and Acid Yellow 7 (Chemical Abstract Service Registry Number 2391-30-2, for 1H-Benz(de) isoquinoline-5-sulfonic acid, 6-amino-2,3-dihydro-1,3-dioxo-2-p-tolyl-, monosodium salt (8CI)). Other suitable inert fluorescent moieties are described and claimed in pending U.S. patent application Ser. No. 09/436,189, entitled FLUORESCENT COMPOUNDS FOR USE IN INDUSTRIAL WATER SYSTEMS. U.S. patent application Ser. No. 09/436,189 is incorporated by reference, in its entirety.

The inert moiety, hereinafter the “inert tracer” may be added directly to the water used in semiconductor processes. By monitoring the fluorescent signal of the inert tracer it is possible to determine whether the correct amount of semiconductor process water is present at different stages of the semiconductor manufacturing process. Furthermore, by monitoring the presence of the inert tracer it is possible to tell when additional water is required step in the semiconductor manufacturing process.

The present invention is not limited to the type of process stream that can be fluorometrically monitored. In addition to semiconductor process water, the semiconductor process stream can include a variety of different process streams each including a variety of different components.

The present invention provides a method of fluorometric monitoring of the water used in semiconductor chip production. As previously discussed, the fluorometric monitoring of the water used in semiconductor manufacturing is quick and accurate such that determinations regarding the semiconductor chip production can be readily and reliably made.

Changes can be made in the composition, operation and arrangement of the method of the present invention described herein without departing from the concept and scope of the invention as defined in the following claims:

1. A fluorometric method of ascertaining the purity of water used in semiconductor processing comprising the steps of:
a) providing the water used in semiconductor processing;
b) providing a modular fluorometer comprising from one to 16 individual modular fluorometer units;
c) moving a sample of water from said water used in semiconductor processing through the channel of said modular fluorometer;
d) using said modular fluorometer units to detect the fluorescent signal detectable at from one to sixteen emission wavelengths;
e) comparing the detected fluorescent signals with the quality control settings for allowable fluorescent signals and using this comparison to determine whether said water used in said semiconductor process is acceptable.

2. A fluorometric method for monitoring and optionally controlling a semiconductor chip manufacturing process, the method comprising the steps of:
a) providing water suitable for use in a semiconductor chip process stream;
b) providing at least one suitable fluorometer;
c) providing a suitable inert fluorescent moiety;
d) adding said suitable inert fluorescent moiety to said water suitable for use in a semiconductor chip process stream;
e) using said fluorometer to detect the fluorescent signal of said suitable inert fluorescent moiety; and
f) using the fluorescent signal of said suitable inert fluorescent moiety to monitor and optionally control said semiconductor chip manufacturing process.
